(19) United States
(12) Patent Application Publication
(10) Pub. No.: US 2004/0168124 A1
(43) Pub. Date: Aug. 26, 2004

(54) System and method of mapping between software objects & structured language element-based documents

(76) Inventors: Michael Beisiegel, Poughkeepsie, NY (US); John Green, Toronto (CA); Jay W. Warfield, Raleigh, NC (US)

Correspondence Address: Diana L Roberts, International Business Machines, Intellectual Property Law, 11400 Burnet Road, Austin, TX, 78758, US

(21) Appl. No.: 10/479,671

(22) PCT Filed: Dec. 28, 2001
(86) PCT No.: PCT/US01/49577

(30) Foreign Application Priority Data
Jun. 7, 2001 (CA) 2,349,905

(51) Int. Cl. G06F 17/00

(52) U.S. Cl. 715/513; 715/530

(57) ABSTRACT

A method and system that provides a common framework for mapping between a document (e.g. an XML document) and a software object (e.g. a Java object). The framework uses a handler that masks how a property is obtained for mapping. This results in mapping code that has a common appearance for both directions of mapping. A mapping between elements of an XML document and the properties of a Java object is contained in a mapper. A mapper maps from the XML document (108) to an object (110) using a parser (104) (such as DOM or SAX). Mapping in the other direction (Java to XML) requires that the elements of the XML document (118) be built in a particular order to ensure validity of the resulting XML document (118). The present invention builds an XML template document using JSP, for example. Using JSP based templates enables tags of the document to be written in the JSP, with callbacks to get element and attribute values. Further, content can be directed to a buffer, or directly to a response stream of a servlet.

### FIELD OF THE INVENTION

The present invention relates to the field of converting or mapping between a software object and a structured language element document, and in particular to mapping between various software objects such as Java™ objects and Extensible Markup Language (XML) documents.

### BACKGROUND OF THE INVENTION

Extensible Markup Language (XML) is a pared down version of Standard Generalized Markup Language (SGML) that is designed especially for Web documents. It enables designers to create their own customized tags to provide functionality not available with HTML. For example, XML supports links that point to multiple documents, as opposed to HTML links, which can reference just one destination each.

Because XML is a form of self-describing data (also termed structured language elements in the present description), it is used to encode rich data models. Therefore, XML is useful as a data exchange medium between dissimilar systems. Data can be exposed or published as XML from many kinds of systems: legacy COBOL programs, databases, C++ programs and the like. A business problem that is commonly encountered involves resolving how to map information from an XML document to other data formats and vice versa. For example, once information has been exchanged between entities in an XML document, it may be necessary to map its information into a Java object that can be used when making a database or transactional request.

U.S. Pat. No. 6,125,391 issued Sep. 26, 2000 to Meltzer et al. discloses an example of an XML/Java conversion tool. For converting from XML to Java, Meltzer et al. parse the XML document and raise events. In particular, a parser walks through an XML document and builds a tree representation in memory that can be queried and another parser walks an XML document and raises events with information about the document (e.g., start document event, start element vent with the name of the element, content of the element, end element event, end document event, etc.).

For converting from Java to XML, Meltzer et al. generates code that contains accessors for each element. The accessor for an element contains a loop, looping for each character. The loop contains a switch statement that performs an action based on what the character is. The action is to build a StringBuffer containing the element fragment of the XML document. The Meltzer et al. solution does not provide supporting infrastructure for working with the code that transforms Java to XML. All the code in Meltzer et al. is generated and is not conducive for a user to edit.

Consequently, there is a need for a mapping framework to support mapping between software objects and structured language element based documents (e.g. XML) that can be efficiently implemented using standard tools.

### SUMMARY OF THE INVENTION

The disadvantages of the prior art summarized above are overcome according to an exemplary method and system of the present invention that provides a common framework for mapping between a document (e.g. an XML document) and a software object (e.g. a Java object). The framework uses a handler that masks how a property is obtained for mapping. This results in mapping code that has a common appearance for both directions of mapping. A mapping between elements of an XML document and the properties of a Java object is contained in a mapper. A mapper maps from the XML document to a software object through the use of a parser (such as Document Object Model (DOM) or Simple Application Programming Interface (API) for XML (SAX)).

Mapping in the other direction (Java to XML) requires that the elements of the XML document be built in a particular order to ensure validity of the resulting XML document. To ensure this validity, an exemplary embodiment of the present invention builds an XML template document using JavaServer Pages™ (JSP), for example. Using JSP based templates enables tags of the document to be written in the JSP, with callbacks to get element and attribute values. JSP is well documented with editor support to permit efficient template creation. Further, content can be directed to a buffer, or directly to a response stream of a servlet.

In accordance with one aspect of the present invention there is provided a computer-implemented method for converting a data structure representing a software object to structured language elements of a document, the method comprising: (a) generating a structured language element template document; (b) reading properties from the software object, the properties being associated with the structured language elements of the document; (c) using the properties, obtaining constructs defined by the structured language elements based on the association between the properties and the structured language elements; and (d) populating the structured language element template document with the constructs.

In accordance with another aspect of the present invention there is provided a computer-implemented method for converting structured language elements of a document to a data structure representing a software object, the method comprising: (a) reading each of the structured language elements of the document; (b) determining a property, selected from a set of available properties defined by the data structure of the software object, associated with structured language elements of the document; and (c) populating the properties of the data structure representing the software object with structured language element values from the document.

In accordance with another aspect of the present invention there is provided a system for converting a software object containing properties to a document defined by structured language elements, the system comprising: (a) a document template; (b) a handler interface for providing a representation of the structured language elements of the document based on call backs made by the document template; (c) a mapping module, in communication with the handler interface, for converting properties of the software objects to structured language elements recognized by the document; and (d) an output target class, in communication with the mapping module, for writing the structured language elements generated in step (c) to the document.

In accordance with another aspect of the present invention there is provided a system for converting a document containing structured language elements to a software object, the system comprising: (a) a parser for obtaining events representative of features of the document; (b) an input source class for reading the document; (c) a content handler class, in communication with the input source class, for implementing a buffer for the events obtained by the parser; and (d) a mapping module, in communication with the content handler class, for converting the events obtained by the parser to properties for the software object.

In accordance with another aspect of the present invention there is provided a method of converting a software object having properties to a document represented by structured language elements, the method comprising: (a) supplying the software object to an instance of an invoked mapping interface; (b) compiling and executing a template using an instance of an invoked container; and (c) writing the document to a specified output stream using the compiled template.

In accordance with another aspect of the present invention there is provided a method of converting a document containing structured language elements to a software object, the method comprising: (a) supplying the document to an instance of an invoked mapping interface; (b) registering the mapping interface as a content handler; (c) parsing the document using an instance of an invoked parser; and (d) populating the software object with properties associated with structured language elements parsed from the document through call backs made to the mapping interface.

n accordance with another aspect of the present invention there is provided a computer program product for converting a data structure representing a software object to structured language elements of a document, the computer program product comprising computer readable program code devices for: (a) generating a structured language element template document; (b) reading properties from the software object, the properties being associated with the structured language elements of the document; (c) using the properties, obtaining constructs defined by the structured language elements based on the association between the properties and the structured language elements; and (d) populating the structured language element template document with the constructs.

In accordance with another aspect of the present invention there is provided a computer program product for converting structured language elements of a document to a data structure representing a software object, the computer program product comprising computer readable program code devices for: (a) reading each of the structured language elements of the document; (b) determining a property, selected from a set of available properties defined by the data structure of the software object, associated with structured language elements of the document; and (c) populating the properties of the data structure representing the software object with structured language element values from the document.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Further features and advantages of the present invention will be described in the detailed description, taken in combination with the appended drawings, in which:

FIG. 1 is a block diagram of a computer system that may be used to implement a method and apparatus for embodying the invention;

FIG. 2 is a block diagram illustration the framework for mapping between XML and Java objects and vice versa;

FIG. 3 is a flow chart illustrating a method of mapping an XML document to a software object using the framework of FIG. 2; and

FIG. 4 is a flow chart illustrating a method of mapping a software object to an XML document using the framework of FIG. 2.

### DETAILED DESCRIPTION OF EMBODIMENTS OF THE PRESENT INVENTION

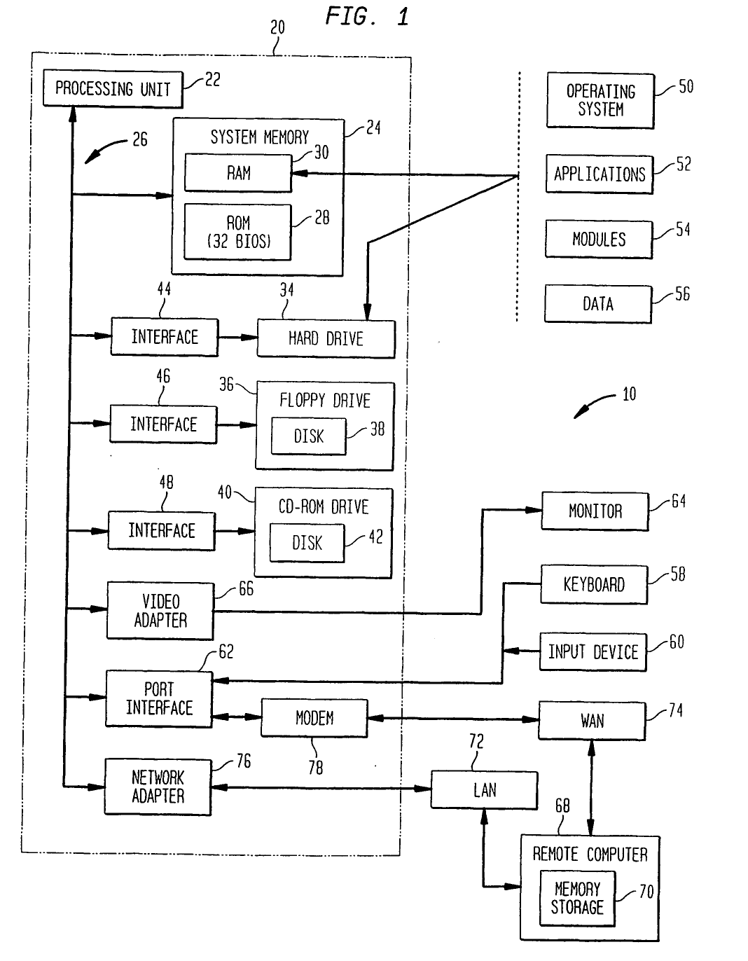

FIG. 1 and the associated description represent an example of a suitable computing environment in which the invention may be implemented. While the invention will be described in the general context of computer-executable instructions of a computer program that runs on a personal computer, the invention can also be implemented in combination with other program modules.

Generally, program modules include routines, programs, components, data structures and the like that perform particular tasks or implement particular abstract data types. Further, the present invention can also be implemented using other computer system configurations, including hand-held devices, multiprocessor systems, microprocessor-based or programmable consumer electronics, minicomputers, mainframe computers and the like. The invention can also be practiced in distributed computing environments where tasks are performed by remote processing devices that are linked through a communications network. In a distributed computing environment, program modules may be located in both local and remote memory storage devices.

With reference to FIG. 1, an exemplary system 10 includes a conventional personal computer 20, including a processing unit 22, a system memory 24, and a system bus 26 that couples various system components including the system memory 24 to the processing unit 22. The system bus 26 includes several types of bus structures including a memory bus or memory controller, a peripheral bus, and a local bus using any of a variety of conventional bus architectures (e.g., PCI, VESA, ISA, EISA etc.)

The system memory 24 includes read only memory (ROM) 28 and random access memory (RAM) 30. A basic input/output system (BIOS) 32, containing the basic routines that help to transfer information between elements within the computer 20, such as during start-up, is stored in the ROM 28. The computer 20 also includes a hard disk drive 34, magnetic disk drive 36 (to read from and write to a removable disk 38), and an optical disk drive 40 (for reading a CD-ROM disk 42 or to read from or write to other optical media). The drives 34, 36 and 40 are connected to the system bus 26 by interfaces 44, 46 and 48, respectively.

The drives 34, 36 and 40 and their associated computer-readable media (38, 42) provide nonvolatile storage of data, data structures, and computer-executable instructions for the computer 20. The storage media of FIG. 1 are merely examples and it is known by those skilled in the art to include other types of media that are readable by a computer (e.g., magnetic cassettes, flash memory cards, digital video disks, etc.).

A number of program modules may be stored in the drives 34, 36 and 40 and the RAM 30, including an operating system 50, one or more application programs 52, other program modules 54 and program data 56. A user may enter commands and information into the computer 20 through a keyboard 58 and an input device 60 (e.g., mouse, microphone, joystick, game pad, satellite dish, scanner etc.) These devices (58 and 60) are connected to the processing unit 22 through a port interface 62 (e.g., serial port, parallel port, game port, universal serial bus (USB) etc.) that is coupled to the bus 26. A monitor 64 or other type of display device is also connected to the bus 26 through an interface 66 (e.g., video adapter).

The computer 20 may operate in a networked environment using logical connections to one or more remote computers, such as remote computer 68. The remote computer 68 may be a server, a router, a peer device or other common network node, and typically includes many or all of the elements described in relation to the computer 20, although for simplicity only a memory storage device 70 is shown. The logical connections shown in FIG. 1 include a local area network (LAN) 72 and a wide area network (WAN) 74. Such networking environments are commonly used in offices, enterprise-wide computer networks, intranets and the Internet.

When used in a LAN networking environment, the computer 20 is connected to the LAN 72 through a network interface or adapter 76. When used in the WAN networking environment, the computer 20 typically includes a modem 78 or other means for establishing communications over the WAN 74, such as the Internet. The modem 54, which may be internal or external, is connected to the bus 26 through the port interface 62. In a networked environment, program modules depicted relative to the computer 20, or portions thereof, may be stored in the remote memory storage device 70.

Discussion of the method of the present invention is based in terms of conversion/mapping from XML to Java objects and from Java objects to XML. Other data formats are also supported. For example, many legacy business applications are written in COBOL, C and PL1. These applications are composed of programs that reside in Enterprise Information Systems (EIS) such as CICS™ (general purpose online transaction processing software) or IMS™ (Information Management System). A COBOL program uses COBOL structures for their input and output. There is a need to map from XML to COBOL and from COBOL to XML. The present invention can be used to perform these maps, where a XML-to-object X mapping handler (discussed below) would populate a COBOL structure from the XML document and an object-X-to-XML mapping handler (discussed below) would extract the data from a COBOL structure and be used by a template to populate the XML document.

By way of background, the mapping methods of the present invention utilize the following high level process: (a) a lexer groups characters into words or tokens that are recognized by a particular system (termed tokenizing); (b) a parser analyses groups of tokens in order to recognize legal language constructs; and (c) a code generator takes a set of legal language constructs and generates executable code. The functions defined by (a)-(c) can be intermixed.

For example, for XML to Java object mapping, every character in a XML document is analyzed in order to recognize legal XML tokens such as start tags, properties, end tags and “CDATA” sections. Then, the tokens must be verified that they form legal XML constructs. At a most basic level, it is verified that all of the tagging has matching opening and closing tags and the properties are properly structured in the opening tag. If Document Type Definitions (DTD) or XML schema are available, then it is possible to ensure that the XML constructs found during parsing are legal in terms of the DTD or XML schema as well as being well-formed XML. Finally, the data contained in the XML document is used to accomplish something useful (i.e. map it into a Java object).

Some of the tasks identified above can be performed, at least in-part, by readily available XML parsers. XML parsers handle the lexical analysis and parsing tasks. Two example parsing standards are the SAX and DOM APIs (SAX—Simple Application Programming Interface (API) for XML; DOM—Document Object Model).

SAX is event-based. XML parsers that implement SAX generate events that correspond to different features found in the parsed XML document. The DOM API is an object-model-based API. XML parsers that implement DOM create a generic object model in memory that represents the contents of the XML document. Once the XML parser has completed parsing, the memory contains a tree of DOM objects that offers information about both the structure and contents of the XML document.

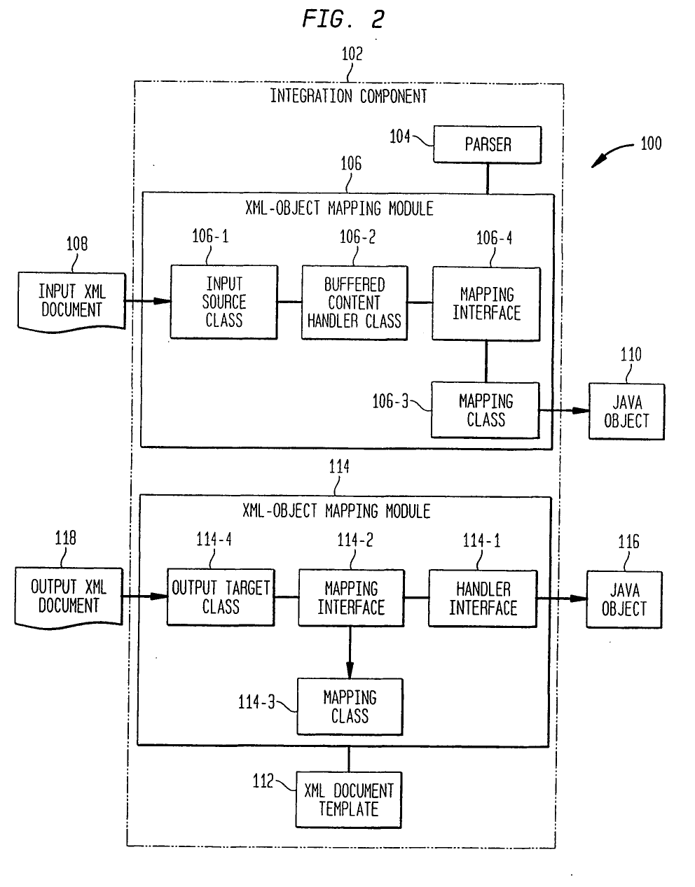

FIG. 2 illustrates a schematic representation of a framework 100 according to an embodiment of the present invention. The framework 100 is shown instantiated in an integration component 102 such as a Servlet that can be executed in the system 10 of FIG. 1. The integration component 102 includes a parser 104 implemented using DOM or SAX, for example, that interacts with an XML-OBJECT mapping module 106. For clarity, SAX will be discussed as an example of the parser 104 in describing the implementation embodiments of the present invention.

The XML-OBJECT mapping module 106 receives an input XML document 108 and generates an output Java object 110. The integration component 102 further includes an XML document template module 112 (e.g. based on JavaServer Pages™—JSP technology) that communicates with an OBJECT-XML mapping module 114. The OBJECT-XML mapping module 114 receives an input Java object 116 and generates an output XML document 118.

XML to Software Object Mapping

With reference to FIG. 2, the XML-OBJECT mapping module 106 includes the following components:

(a) an input source class 106-1 (XML2xInputSource) for implementing the input XML document 108;

(b) a buffered content handler class 106-2 (XML2xBufferedContentHandler) for implementing a buffer for SAX events generated by the parser 104;

(c) a mapping interface 106-3 (XML2xMapping) for executing the mapping and for setting input and output target streams; and

(d) a mapping class 106-4 (XML2xMappingImpl) that provides methods for mapping from the input XML document 108 to the output Java object 110.

Further details of the various interfaces and classes are discussed below. The terms “class” and “interface” have specific meanings in Java. A Java class (abstract, inner or final) is a collection of data members and methods that define a particular object and a Java interface is used to impose certain functionality on a class that implement them (i.e. interfaces specify what classes must do). Interfaces are also used to provide constants that can be used by the classes that implement the interface. Interfaces contain constant variables and method declarations, but the implementation of the methods is left to the classes that implement the interface. A class can implement any number of interfaces.

Table M106-1 summarizes the main functions (i.e., not exhaustive) of the input source class 106-1 (XML2xInputSource).

XML2xInputSource is used so that an XML document can be read from a byte stream, a character stream or the XML2xBufferedContentHandler 106-2.

TABLE M106-1

| FUNCTION | DESCRIPTION |
|---|---|
| available( ) | returns the number of bytes that can be |
| | read from an input stream without blocking. |
| getBufferedHandler ( ) | Gets the SAX event buffered handler. |
| getByteStream ( ) | Returns a byte stream |
| getCharacterStream ( ) | Returns a character stream reader. |
| read ( ) | Reads the next byte of data from this |
| | input stream. |
| skip ( ) | Skips bytes of input from this input stream. |

Table M106-2 summarizes the main functions (i.e., not exhaustive) of the buffered content handler class 106-2 (XML2xBufferedContentHandler). The handler class 106-2 also includes a content handler to buffer SAX events from the parser 104. This allows events to be replayed. An example where this feature is useful is where different mapping handlers are used for different portions of an XML document. An implementation example is the Simple Object Access Protocol (SOAP).

TABLE M106-2

| FUNCTION | DESCRIPTION |
|---|---|
| characters (char[] | Method comment where ch are characters |
| ch, int start, int length); | from the XML document 108; start is the |
| | start position in the array; length is the |
| | number of characers to read from the array |
| parse ( ) | Executes SAX events in the buffer |

SOAP is a lightweight protocol for exchange of information in a decentralized, distributed environment. It is an XML based protocol that consists of three parts: (1) an envelope that defines a framework for describing what is in a message and how to process it; (2) a set of encoding rules for expressing instances of application-defined data types; and (3) a convention for representing remote procedure calls and responses. A SOAP message is an XML document that consists of a mandatory SOAP envelope, an optional SOAP header, and a mandatory SOAP body. In this situation, it is possible to use a different mapping handler for the envelope and the body.

Table M106-3 summarizes the main functions (i.e., not exhaustive) of the mapping interface 106-3 (XML2xMapping). XML2xMapping executes the mapping and allows configuration of the InputStream.

TABLE M106-3

| FUNCTIONS | DESCRIPTION |
|---|---|
| execute( ) | Performs the mapping that will create the format from |
| | the input XML document 108. A full example of |
| | execute( ) is provided below. |
| setInputStream( ) | Sets the input stream - i.e., specifies the source of the |
| | Input XML document 108 that is to be mapped. |

Table M106-4 summarizes the main functions (i.e., not exhaustive) of the mapping class 106-4 (XML2xMappingImpl). As discussed above in relation to the definitions of class and interface, the XML2xMappingImpl class is not used directly, but is sub-classed with content added to appropriate methods depending on document type definitions for the input XML document 108 to be mapped from the output Java object 110 it is mapping to.

TABLE M106-4

| FUNCTION | DESCRIPTION |
|---|---|
| EndElement( ) | Receives notification of the end of an |
| | element. The parser 104 will invoke this method |
| | at the end of every element in the input XML |
| | document 108. There is a corresponding |
| | startElement( ) event for every endElement - |
| | event even when the element is empty. |
| execute( ) | Performs the mapping that will create the |
| | format from the input XML document 108 |
| setDocumentLocator( ) | Receives an object for |
| | locating the orgin of SAX |
| | document events. |
| setInputStream( ) | Sets the input stream. Specifies |
| | the source for the XML |
| | document that is to be mapped. |
| startElement( ) | Receives notification of the beginning |
| | of an element. The parser 104 invokes this |
| | method at the beginning of every element |
| | in the input XML document 108. There |
| | is a corresponding endElement( ) event for every |
| | startElement( ) event - even when the |
| | element is empty. All of the element's |
| | content is reported, in order, before |
| | the corresponding endElement( ) event. |

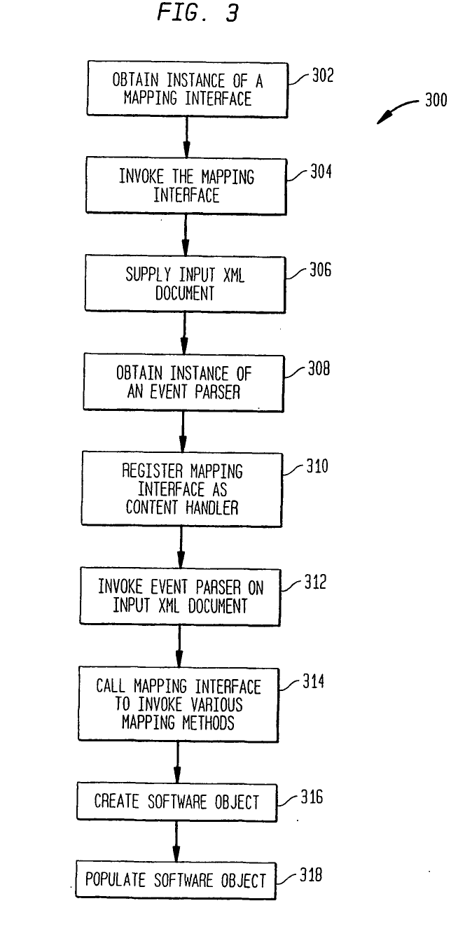

With reference to FIG. 3, a method 300 is illustrated showing the general steps that are performed to map the XML document 108 to the software object 110 (e.g., a Java Bean):

(a) obtain an instance of the mapping interface 106-4 (e.g., XML2xMapping) for implementing the mapping from XML to object X at step 302;

(b) invoke the mapping interface 106-4 at step 304 and supply the input XML document 108 at step 306;

(c) the mapping interface 106-4 obtains an instance of an event parser (e.g., the parser 104) at step 308 and registers the mapping interface 106-4 as a content handler (e.g., buffered content handler class 106-2) at step 310;

(d) invoke the parser 104 on the XML document 108 (i.e., begin parsing the document) at step 312;

(e) as step (d) is performed, call backs occur to the mapping interface 106-4 invoking various methods at step 314 (e.g., startDocument, startElement, characters, endElement, endDocument, etc.);

(f) in the startDocument and/or startElement methods the mapping interface 106-4 creates the software object 110 at step 316; and

(g) in the endElement method the mapping interface 106-4 sets the element into the software object 110 at step 318.

The SAX API, discussed above, includes many specifications known in the art. The present invention is concerned with creating a class that implements a “ContentHandler” interface, which is a callback interface used by XML parsers to notify a program of SAX events as they are found in the XML document. The interface is used with the XML2xBufferedContentHandler class 106-2 and the XML2xInputSource class 106-1. The SAX API also provides a “DefaultHandler” implementation class for the “ContentHandler” interface. An example I “XML-JAVA CUSTOMER”, detailed below, extends the “DefaultHandler” to generate a customer Java Bean from a customer XML document.

### EXAMPLE I

### XML-Java Customer

The following components (detailed below) are part of example I:

(A) customer.xml: the input XML document 108 sample;

(B) XML2CustomerMapping.java: the handler class 106-2 that the parser 104 calls back to. It contains the instructions to construct the customer object and establish its values;

(C) execute.java: the program of the mapping class/interface 106-3, 106-4 used to execute mapping from XML to Java and from Java to XML (for Example II below);

(D) customer.java: the output customer Java Bean 110; and

(E) CustomerSymbols.java: contains integer constants and a hashmap. The hashmap is used to map the names of tags to integer constants for use in XML2CustomerMapping.java.

A. Input XML document (customer.xml) is provided below.

```
//START customer.xml
<?xml version=“1.0”?>
<customer>
  <FirstName>Jane</FirstName>
  <LastName>Doe</LastName>
  <CustId>xyz.123</CustId>
</customer>
//END customer.xml
```

B. A program (XML2CustomerMapping.java), with some reductions for conciseness, to construct the customer object and to set values into it (i.e. a handler that the event parser calls back to) is provided below.

```
//START XML2CustomerMapping.java
public class XML2CustomerMapping extends
com.xxx.xml2xmapping.XML2xMappingImpl {
  private StringBuffer fieldCurrentQualifiedElementName = new
StringBuffer(“”);
  private Customer fieldCustomer;
  private Stack elementStack;
  * XMLCustomerInfo2RecordCustomerInfoMapper constructor
  comment.
public XML2CustomerMapping( ) {
  super( );
  elementStack = new Stack( );
}
  * characters method comment.
public void characters(char[] ch, int start, int length) throws
org.xml.sax.SAXException {
  switch (this.fieldCurrentElementSymbol) {
    case CustomerSymbols.CUSTOMER_FIRSTNAME:
    case CustomerSymbols.CUSTOMER_LASTNAME:
    case CustomerSymbols.CUSTOMER_ID:
((StringBuffer)elementStack.lastElement( )).append(ch,start,length
);
      break;
  }
}
  * endElement method comment.
public void endElement(String namespaceURI, String localName,
String rawName) throws org.xml.sax.SAXException {
  String symbolName;
  if (namespaceURI.equals(“”)) symbolName = rawName;
  else symbolName = namespaceURI + “_” + localName;
  this.fieldCurrentElementSymbol =
CustomerSymbols.getSymbol(symbolName);
  // Get the value
  String value =
((StringBuffer)elementStack.pop( )).toString( );
  switch (this.fieldCurrentElementSymbol) {
    case CustomerSymbols.CUSTOMER_FIRSTNAME: {
      this.fieldCustomer.setFirstName(value);
      break;
    }
    case CustomerSymbols.CUSTOMER_LASTNAME: {
      this.fieldCustomer.setLastName(value);
      break;
    }
    case CustomerSymbols.CUSTOMER_ID: {
      this.fieldCustomer.setId(value);
      break;
    }
  }
  this.fieldCurrentElementSymbol = 0;
}
* @return com.xxx.connector.mapping.xml.test.Customer
public Customer getCustomer( ) {
  return this.fieldCustomer;
}
  * startElement method comment.
public void startElement(String namespaceURI, String localName,
String rawName, org.xml.sax.Attributes atts) throws
org.xml.sax.SAXException {
  String symbolName;
  if (namespaceURI.equals(“”)) symbolName = rawName;
  else symbolName = namespaceURI + “_” + localName;
  this.fieldCurrentElementSymbol =
CustomerSymbols.getSymbol(symbolName);
  elementStack.push(new StringBuffer( ));
  switch (this.fieldCurrentElementSymbol) {
    case CustomerSymbols.CUSTOMER: {
      this.fieldCustomer = new Customer( );
      break;
    }
  }
}
}
//END XML2CustomerMapping.java
```

C. A program (execute.java), with reductions for conciseness, used to execute mapping from XML to Java (and from Java to XML as detailed in Example II below).

```
//START execute.java
package com.xxx.xml2xmapping.sample.customer;
import java.io.*;
import org.xml.sax.*;
public class Execute {
  * Execute constructor comment.
public Execute( ) {
  super( );
}
  * Starts the application.
  * @param args an array of command-line arguments
public static void main(java.lang.String[] args) {
  int numIterations = 1;
  XML2CustomerMapping inMapping = new
  XML2CustomerMapping( );
  Customer2XMLMapping outEventBasedMapping = new
Customer2XMLMapping( );
// Create the XML2Customer handler and the Customer2XML handler
XML2CustomerMapping in Mapping = new
XML2CustomerMapping( );
Customer2XMLMapping outEventBasedMapping = new
Customer2XMLMapping( );
// read in the customer.xml file
  ByteArrayInputStream inStream = null;
  try {
    FileInputStream fileInputStream = new
FileInputStream(“customer.xml”);
    byte[] bytes = new byte[fileInputStream.available( )];
    fileInputStream.read(bytes, 0,
fileInputStream.available( ));
    inStream = new ByteArrayInputStream(bytes);
  } catch (Exception e) {
    e.printStackTrace( );
  }
  ByteArrayOutputStream outStream = new
ByteArrayOutputStream( );
  try {
  long ts = System.currentTimeMillis( );
  for (int i=0; i<numIterations; i++) {
    // inbound mapping
    // map from XML document to customer Java Bean
    inStream.reset( );
    inMapping.setInputStream(inStream);
    inMapping.execute( );
    // some execution, here a connector would be called
    // get the customer object and print its contents
    Customer aCustomer = inMapping.getCustomer( );
    System.out.println(“First name from XML document is
”+aCustomer.getFirstName( ));
    System.out.println(“Last name from XML document is
”+aCustomer.getLastName( ));
    System.out.println(“Customer id from XML document is
”+acustomer.getId( ));
    // Change the values on the customer object
    aCustomer.setFirstName(“James”);
    aCustomer.setLastName(“Bond”);
    aCustomer.setId(“007”);
    // outbound mapping
    // map from Java to XML
    outEventBasedMapping.setCustomer(aCustomer);
    //outEventBasedMapping.setOutputStream(outStream);
    outEventBasedMapping.setOutputStream(System.out);
    outEventBasedMapping.execute( );
  }
  long te = System.currentTimeMillis( );
  System.out.println(“Average time ”+(te-
ts)/numIterations+“ms.”);
  } catch (Exception e) {
    e.printStackTrace( );
  }
}
}
//END execute.java
```

D. A customer Java Bean (customer.java) is detailed below. A Java Bean is a reusable component that adheres to a standard design architecture known in the art. A Bean is a class object that may or may not be visible at run time. JavaBeans provide a component architecture, a standard framework for developing components.

```
//START customer.java
package com.xxx.xml2xmapping.sample.customer;
public class Customer {
  private java.lang.String fieldFirstName = new String( );
  private java.lang.String fieldLastName = new String( );
  private java.lang.String fieldId = new String( );
* Customer constructor comment.
public Customer( ) {
  super( );
}
* Gets the firstName property (java.lang.String) value.
  * @return The firstName property value.
  * @see #setFirstName
public java.lang.String getFirstName( ) {
  return fieldFirstName;
}
* Gets the id property (java.lang.String) value.
  * @return The id property value.
  * @see #setId
public java.lang.String getId( ) {
  return fieldId;
}
* Gets the lastName property (java.lang.String) value.
  * @return The lastName property value.
  * @see #setLastName
public java.lang.String getLastName( ) {
  return fieldLastName;
}
* Sets the firstName property (java.lang.String) value.
  * @param firstName The new value for the property.
  * @see #getFirstName
public void setFirstName(java.lang.String firstName) {
  fieldFirstName = firstName;
}
* Sets the id property (java.lang.String) value.
  * @param id The new value for the property.
  * @see #getId
public void setId(java.lang.String id) {
  fieldId = id;
}
/**
  * Sets the lastName property (java.lang.String) value.
  * @param lastName The new value for the property.
  * @see #getLastName
public void setLastName(java.lang.String lastName) {
  fieldLastName = lastName;
}
}
//END customer.java
```

As shown in Example I, mapping from XML to Java is efficient because the parser 104 processes events for all start, element and end tags, which improves tracking of the events.

As a further example, consider expanding the single customer XML document to an array of customers. To generate an array of customer java beans follow this procedure:

(i) use the startElement for Customers to create a vector;

(ii) in the startElement for each Customer create a Customer object; and

(iii) use the startElement, getElement, endElement events for FirstName, LastName, and CustID to populate the Customer object, endElement for Customer to insert the Customer object into the vector, and endElement for Customers to create an array of Customers from the vector and set it into the Java object being working with.

A stack is maintained by the parser 104 for recursive XML structures (i.e., XML elements that represent lists of lists). For each startElement an object is created. The stack can be used to keep state as required. Once a child element is created it can be set into its parent object.

Software Object to XML Mapping

With reference to FIG. 2, the OBJECT-XML mapping module 114 includes the following components:

(a) a handler interface 114-1 (X2XMLHandler) for managing parsing events;

(b) a mapping interface 114-2 (X2XMLMapping) for executing the mapping and setting an output target stream;

(c) a mapping class 114-3 (X2XMLMappingImpl) that provides methods for mapping from the input Java object 116 to the output XML document 118; and

(d) an output target class 114-4 (X2XMLOutputTarget) to implement the output XML document 118.

Table M114-1 summarizes the main functions (i.e., not exhaustive) of the handler interface 114-1 (X2XMLHandler). The mapping module 114 implements the interface 114-1 and registers an instance with a JSP container. The document template 112 makes call backs to the mapping module 114 for basic document related events like the start and end of elements and to get an element value.

TABLE M114-1

| FUNCTION | DESCRIPTION |
|---|---|
| getElementValue( ) | Returns the value of an element. |
| | This is used when working with simple types |
| | that are not scoped by start and end element tags. |
| endElement( ) | Receives notification of the end |
| | of an element. This is used for maintaining |
| | state when working with a complex type. |
| getElementAttribute( ) | Returns the specified |
| | attribute's value. This is used |
| | when working with a complex type |
| | that is scoped by start and end element tags. |
| getElement- | For a repeating element, his |
| Repetitions( ) | returns the number of repetitions. |
| isOptionalAttribute- | Returns true if the optional |
| Present( ) | attribute is present, otherwise returns |
| | false. This is used in the XML |
| | document template (JSP) 112 for |
| | controlling whether name and value are |
| | generated for an optional attribute |
| | in the XML document 118. This is used |
| | when working with a complex type that |
| | is scoped by start and end |
| | element tabs. |
| startElement( ) | Receives notification of the |
| | beginning of an element. |
| | This is used for maintaining state |
| | when working with complex types. |

In general, a container is an entity that provides life cycle management, security, deployment and runtime services to components. There are many specific types of containers (Web, JSP, servlet, applet etc.) that provide component-specific services. A servlet container is a container that provides network services over which requests and responses are sent, decodes requests, and formats responses. A JSP container is a container that provides the same services as a servlet container and an engine that interprets and processes JSP pages into a servlet.

X2XMLHandler 114-1 provides a mirror (although not identical) image of parsing events to that produced by the parser 104. In effect, the structure provided by the parser 104 is mirrored in the path from X2XML.

When the parser 104 is implemented using SAX the events are received by the handler 106-2 (i.e., effectively a callback mechanism) that processes them. In this example, the handler 106-2 is used to populate a Java class.

When the template 112 is invoked, it calls back to the X2XMLHandler interface 114-1. The handler 114-1 processes the callback by obtaining the requested data and maintaining the state of parsing.

While the handler interface 114-1 is similar in terms of the various functions performed by the XML-OBJECT mapping module 106 there are certain differences. An element name is generated or hand coded, and is not taken from a schema with “namespace” support. The element name can be made unique for each element. Therefore, only a name parameter is required on the startElement and endElement methods.

When mapping is performed by the XML-OBJECT mapping module 106, the input source class 106-1 (i.e., an XMLReader) returns the name of the element as a string. In the mapping class/interface 106-3, 106-4 the element name is paired with a unique number. This number is used in a switch statement to control the processing of the elements. In the OBJECT-XML module 114, processing is optimized and coding assistance is improved by defining the element name as an integer constant. Therefore, callbacks to these methods use integer constants instead of strings.

The order of events in the handler interface 114-1 mirrors the order of information in the object 116 themselves.

The XML document template 112 (written using JavaServer Pages technology), uses the coding style detailed below. JSP technology separates the user interface from content generation enabling changing to the overall page layout without altering the underlying dynamic content. JavaServer Pages is an extension of the Java Servlet technology, which is well known to those skilled in the art.

XML Document Template 112—JSP Coding Style Example

Callbacks are coded for the start and end tags of the document 118 and for complex types. This allows the handler 114-1 to maintain state. In the JSP XML document template 112, the start and end tags are also coded directly so that they will be directed to the targeted output stream. When working with a simple type, callbacks do not have to be coded, but start and end tags should still be coded so that they will be directed to the target output stream.

If a complex or simple type is optional then isOptionalElementPresent( ) is used in a conditional clause within the template 112 to control whether the optional element is generated.

If an attribute is optional then isOptionalAttributePresent(int attributeName) is used in a complex type and a isOptionalAttributePresent(int elementName, int attributeName) in a simple type. If the element type is a repeating simple type then determine if it contains an optional attribute using a isOptionalAttributePresent(int index, int elementName, int attributeName) method.

For repeating elements, getElementRepetitions method is used to return the number of repeating elements. This is used to construct a loop in the template 112 to process each element. For simple types, the template 112 should contain the start and end tags and call a getElementValue(int index, int elementName) to obtain the value. For complex types, since state must be maintained the template 112 should invoke the startElement(int index, int elementName) and endElement(int index, int elementName) methods.

Table M114-2 summarizes the main functions (i.e., not exhaustive) of the mapping interface 114-2 (X2XMLMapping). The mapping interface 114-2 executes the mapping function (between Java and XML) and establishes an output target stream. The mapping interface 114-2 extends the handler interface 114-1, which provides the document template 112 call back methods necessary for generating the output XML document 118.

TABLE M114-2

| FUNCTION | DESCRIPTION |
|---|---|
| execute( ) | Performs the mapping that will create the |
| | output XML document 118. |
| setOutputStream( ) | Sets the output stream to which the output XML |
| | document 118 will be generated. |

Table M114-3 summarizes the main functions (i.e., not exhaustive) of the mapping class 114-3 (X2XMLMappingImpl). The mapping class 114-3 provides the methods for mapping from the input Java object 116 to the output XML document 118. As discussed above in relation to the definitions of class and interface, the X2XMLMappingImpl class 114-3 is not used directly, but is sub-classed with content added to appropriate methods depending on document type definitions for the output XML document 118 to be mapped to and the input Java object 116 it is mapping from.

TABLE M114-3

| FUNCTION | DESCRIPTION |
|---|---|
| execute( ) | Performs the mapping that will create the |
| | output XML document 118. |
| setOutputStream( ) | Sets the output stream to which the output XML |
| | document 118 will be generated. |

Table M114-4 summarizes the main functions (i.e., not exhaustive) of the output target class 114-4 (X2XMLOutputTarget).

X2XMLOutputTarget class 114-4 allows the XML document 118 to be written to a byte stream or a character stream. Class 114-4 provides optimizations, such as allowing the byte stream to be targeted to the output stream of a servlet. Therefore, the XML document 118 is not buffered before being written out.

TABLE M114-4

| FUNCTION | DESCRIPTION |
|---|---|
| close( ) | Closes output stream and releases any system resources |
| | associated with the stream. |
| flush( ) | Flushes output stream and forces any buffered output |
| | bytes to be written out |
| write( ) | Writes bytes from a specified byte array to the output |
| | stream |

In summary, the X2XMLMappingImpl class 114-3 implements the X2XMLMapping interface 114-2. The X2XMLMapping interface 114-2 extends the X2XMLHandler interface 114-1. Therefore, the X2XMLMappingImpl class 114-3 implements the methods defined in the X2XMLHandler interface 114-1.

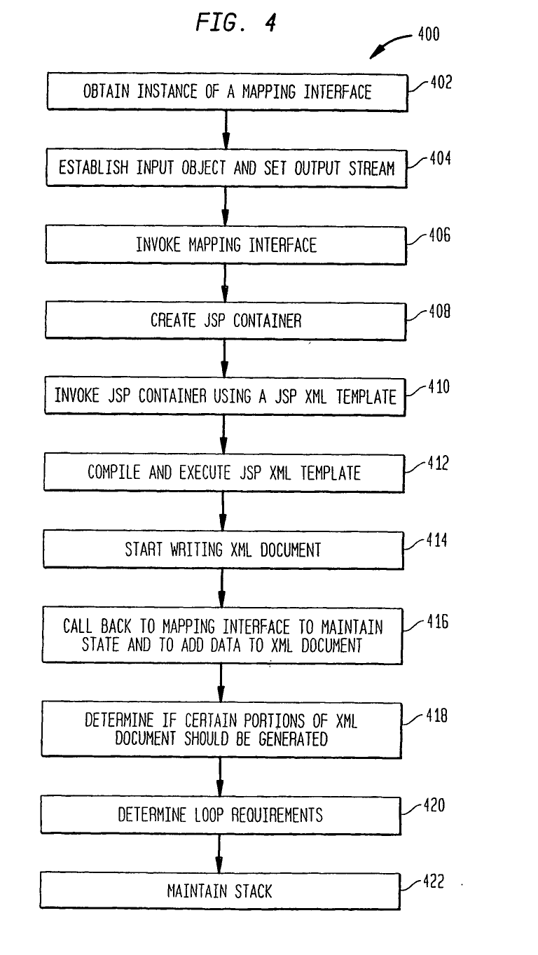

With reference to FIG. 4, a method 400 is illustrated showing the general steps that are performed to map the software object 116 (e.g., a Java Bean) to the XML document 118:

(a) obtain an instance of the mapping interface 114-2 (e.g., X2XMLMapping) for implementing the mapping from input object X 116 to the output XML document 118 at step 402;

(b) set the software object 116 and an output stream for the XML document 118 in the mapping interface 114-3 at step 404;

(c) invoke the mapping interface 114-2 at step 406;

(d) create a JSP container at step 408;

(e) the mapping interface 114-2 invokes the JSP container using the JSP XML template 112 that will create the XML document 118 at step 410;

(f) the JSP container compiles and executes the JSP XML template 112 at step 412;

(g) the compiled JSP XML template 112 starts writing, at step 414, the XML document 118 to the specified output stream (from step 404);

(h) when appropriate for element/attribute data and for start/end tags, at step 416, the compiled JSP XML template 112 calls back to the mapping interface 114-2 to maintain state of processing and to add data to the output XML document 118 (data is retrieved from the software object 116;

(i) the compiled JSP XML template 112 can optionally call, at step 418, an isOptionalElementPresent method or an isOptionalAttributePresent method to determine if certain portions of the XML document should be generated;

(j) the JSP XML template 112 calls back to a getElementRepetitions method to determine how many times it should loop over generation of certain portions of the XML document at step 420; and

(k) the state of processing is maintained by a stack at step 422; this is useful when generating complex types within an XML document where an array occurs, recursion occurs or a complex type is contained within another complex type.

Mapping from Java to XML uses the XML document template 112, which is coded with similar standards imposed by the parser 104, which processes events (at least for complex objects). For example, for complex types, start and end tags must be coded (not required for primitive types). An example II “JAVA-XML CUSTOMER”, detailed below, generates an output customer XML document from a input customer java object.

### EXAMPLE II

### Java-XML Customer

The following components (detailed below) are part of example II:

(A) Customer2XMLMapping.java: the handler class 114-1 that the JSP 112 calls to obtain values from the input customer Java object 116 to populate the output XML document 118;

(B) customer.jsp: the JSP template 112 used to generate the output XML document 118;

(C) CustomerSymbols.java: contains constants and a hashmap. The hashmap is used to map the names of the tags to integer constants. The JSP template 112 uses the integer constants; and

(D) execute.java: the program of the mapping class/interface 114-2, 114-3 used to execute mapping from Java to XML and from XML to Java (as provided above as item C for Example I).

A. A program (Customer2XMLMapping.java), with some reductions of conciseness, to construct the XML document from the input Java object.

```
//START Customer2XMLMapping.java
package com.xxx.xml2xmapping.sample.customer;
import java.util.*;
import com.ibm.xml2xmapping.util.*;
public class Customer2XMLMapping extends
com.xxx.xml2xmapping.X2XMLMappingImpl {
  private Customer fieldCustomer;
/**
  * Customer2XMLMapping constructor comment.
  */
public Customer2XMLMapping( ) {
  super( );
  fieldPageName=“customer.jsp”;
}
/**
  * getElementRepetitions method comment.
  */
public int getElementRepetitions(int name) {
  switch (name) {
  }
  return 0;
}
/**
  * getElementValue method comment.
  */
public String getElementValue(int name) {
  switch (name) {
    case CustomerSymbols.CUSTOMER_FIRSTNAME: {
      return this.fieldCustomer.getFirstName( );
    }
    case CustomerSymbols.CUSTOMER_LASTNAME: {
      return this.fieldCustomer.getLastName( );
    }
    case CustomerSymbols.CUSTOMER_ID: {
      return this.fieldCustomer.getId( );
    }
  }
  return “”;
}
* getElementValue method comment.
public String getElementValue(int index, int name) {
  switch (name) {
  }
  return “”;
}
* @param aCustomer com.xxx.xml2xmapping.sample.customer.
Customer
public void setCustomer(Customer aCustomer) {
  this.fieldCustomer = aCustomer;
}
}
//END Customer2XMLmapping.java
```

B. A document template (Customer.jsp), with some reductions for conciseness, in JSP for module 112.

// START Customer.jsp
<%@ page import=“com.ibm.xml2xmapping.*” %>
<%@ page
import=“com.ibm.xml2xmapping.sample.customer.
CustomerSymbols” %>
<%X2XMLHandler handler =
(X2XMLHandler) request.getAttribute(“com.ibm.xml2xmapping.
X2XMLHandler”);
handler.setWriter(out);%>
<?xml version=“1.0”?>
<customer>
<FirstName><%=handler.getElementValue(CustomerSymbols.
CUSTOMER_FIRST
NAME)%></FirstName>
<LastName><%=handler.getElementValue(CustomerSymbols.
CUSTOMER_LAST
NAME)%></LastName>
<CustId><%=handler.getElementValue(CustomerSymbols.
CUSTOMER_ID)%>
</CustId>
</customer>
//END Customer.jsp

C. A program (Customersymbols.java), with some reductions for conciseness, of a hashmap and constants used by customer.jsp.

```
//START Customersymbols.java
package com.xxx.xml2xmapping.sample.customer;
import java.util.HashMap;
public class CustomerSymbols {
  public static final int CUSTOMER = 1;
  public static final int CUSTOMER_FIRSTNAME = 2;
  public static final int CUSTOMER_LASTNAME = 3;
  public static final int CUSTOMER_ID = 4;
  private static CustomerSymbols fieldInstance;
  private HashMap fieldName2SymbolDictionary;
  private static Object anObject = new Object( );
* CustomerInfoElementSymbols constructor comment.
private CustomerSymbols( ) {
  super( );
  this.fieldName2SymbolDictionary = new HashMap( );
  this.fieldName2SymbolDictionary.put(“customer”, new
Integer(CustomerSymbols.CUSTOMER));
  this.fieldName2SymbolDictionary.put(“FirstName”, new
Integer(CustomerSymbols.CUSTOMER_FIRSTNAME));
  this.fieldName2SymbolDictionary.put(“LastName”, new
Integer(CustomerSymbols.CUSTOMER_LASTNAME));
  this.fieldName2SymbolDictionary.put(“CustId”, new
Integer(CustomerSymbols.CUSTOMER_ID));
}
* @return int
  * @param elementName java.lang.String
public static int getSymbol(String elementName) {
  if (CustomerSymbols.fieldInstance == null) {
    synchronized (anObject) {
      if (CustomerSymbols.fieldInstance == null) {
        CustomerSymbols.fieldInstance = new
CustomerSymbols( );
      }
    }
  }
  return
((Integer)CustomerSymbols.fieldInstance.fieldName2SymbolDictionary.
get(elementName)).intValue( );
}
}
//END Customersymbols.java
```

To generate the XML document for the array of customers situation discussed in conjunction with Example I a sample of the revised customer.jsp is provided below:

for(int i=0;
i<handler.getElementRepetitions(CustomerSymbols.CUSTOMERS);
i++) {
<%handler.startElement(i,CustomerSymbols.CUSTOMER);%>
<customer>
<FirstName>
<%=handler.getElementValue(CustomerSymbols.CUSTOMER_{—}
FIRSTNAME)
%></FirstName>
<LastName>
<%=handler.getElementValue(CustomerSymbols.CUSTOMER_{—}
LASTNAME
) %></LastName>
<CustId><%=handler.getElementValue(CustomerSymbols.CUSTOMER_{—}
ID) %></CustId>
</customer>
<%=handler.endElement(i,CustomerSymbols.CUSTOMER) ;%>
<%}%>

The handler 114-1 determines the array size (i.e., how many loops are to be executed) and returns in the getElementRepitions method. When the customer.jsp calls startElement with the index and name, the handler 114-1 sets a reference to that particular customer object in the array.

To handle recursion, the handler 114-1 uses a stack. As the object recurses, the handler 114-1 pushes onto the stack with a startElement, and pops with the endElement. The working object is the object on top of the stack.

If an object is optional then the isOptionalElement( ) or isOptionalAttribute( ) methods are used to determine if the object exists. The processing in the customer.jsp is revised to add a conditional statement that uses a returned boolean for one of the isOptionalxxx methods. In summary, advantages of an exemplary embodiment of the present include:

(a) providing a common framework for mapping from an XML document to a Java object and from a Java object to an XML document, wherein the framework uses a handler that masks how a property is obtained for mapping;

(b) use of readily available tools (e.g. SAX parser, JSP) to instantiate the mapping methods (XML/Java) of the present invention; and

(c) providing interfaces and classes (in Java environment) that simplify the structure of the mapping process of the present invention and makes the mapping process similar for both mapping directions.

1. A computer-implemented method for converting a data structure representing a software object to structured language elements of a document, the method comprising:
(a) generating a structured language element template document;
(b) reading properties from the software object, the properties being associated with the structured language elements of the document;
(c) using the properties, obtaining constructs defined by the structured language elements based on the association between the properties and the structured language elements; and
(d) populating the structured language element template document with the constructs.

2. The computer-implemented method of claim 1, wherein step (c) includes direct call back to the software object to obtain properties that represent the constructs that define structure and content of the document.

3. The computer-implemented method of claim 1, wherein step (c) includes creating an object model that represents structure and content of the document.

4. The computer-implemented method of claim 1, wherein the structured language elements represent Extensible Markup Language (XML) constructs.

5. The computer-implemented method of claim 1, wherein step (c) includes constructing a loop in the template document to process repeating structures language elements.

6. A computer-implemented method for converting structured language elements of a document to a data structure representing a software object, the method comprising:
(a) reading each of the structured language elements of the document;
(b) determining a property, selected from a set of available properties defined by the data structure of the software object, associated with structured language elements of the document; and
(c) populating the properties of the data structure representing the software object with structured language element values from the document.

7. The computer-implemented method of claim 6, wherein step (a) includes generating events that represent structure and content of the document.

8. The computer-implemented method of claim 6, wherein step (a) includes calling back to a handler with events that represent structure and content of the document.

9. The computer-implemented method of claim 6, wherein step (a) includes creating an object model that represents structure and content of the document.

10. The computer-implemented method of claim 6, wherein the structured language elements represent Extensible Markup Language (XML) constructs and step (a) further includes enforcing Document Type Definition (DTD) and XML schema standards.

11. The computer-implemented method of claim 10, further comprising maintaining a stack for recursive XML constructs.

12. A system for converting a software object (116) containing properties to a document (118) defined by structured language elements, the system comprising:
(a) a document template (112);
(b) a handler interface (114-1)for providing a representation of the structured language elements of the document (118) based on call backs made by the document template (112);
(c) a mapping module(114-2, 114-3), in communication with the handler interface (114-1), for converting properties of the software objects (116) to structured language elements recognized by the document (118); and
(d) an output target class (114-4), in communication with the mapping module (114-2, 114-3), for writing the structured language elements generated in step (c) to the document (118).

13. The system of claim 12, wherein the mapping module includes a mapping interface (114-2) for executing the conversion of the properties to the structured language elements and for setting an output target stream of the document (118) and a mapping class (114-3) for providing methods used by the mapping interface (114-2).

14. The system of claim 13, wherein the output target stream is defined as a buffer.

15. The system of claim 13, wherein the output target stream is defined as a response stream of a servlet.

16. The system of claim 12, wherein the structured language elements represent Extensible Markup Language (XML) constructs.

17. The system of claim 16, wherein the document template is created using JavaServer Pages (JSP).

18. A system for converting a document (108) containing structured language elements to a software object (110), the system comprising:
(a) a parser (104) for obtaining events representative of features of the document (108);
(b) an input source class (106-1) for reading the document (108);
(c) a content handler class (106-2), in communication with the input source class (106-1), for implementing a buffer for the events obtained by the parser (104); and
(d) a mapping module (106-3, 106-4), in communication with the content handler class (106-2), for converting the events obtained by the parser (104) to properties for the software object (110).

19. The system of claim 18, wherein the mapping module includes a mapping interface (106-4) for executing the conversion of the events to the properties and for setting an output target stream of the software object (110) and a mapping class (106-3) for providing methods used by the mapping interface (106-4).

20. The system of claim 19, wherein the structured language elements represent Extensible Markup Language (XML) constructs.

21. A method of converting a software object having properties to a document represented by structured language elements, the method comprising:
(a) supplying the software object to an instance of an invoked mapping interface;
(b) compiling and executing a template using an instance of an invoked container; and
(c) writing the document to a specified output stream using the compiled template.

22. The method of claim 21, further comprising calling back to the mapping interface to maintain state of processing.

23. The method of claim 21, further comprising calling an isOptionalElementPresent method through the compiled template to determine if selected portions of the document are to be generated.

24. The method of claim 21, further comprising calling an isOptionalAttributePresent method through the compiled template to determine if selected portions of the document are to be generated.

25. The method of claim 21, further comprising maintaining a state of processing using a stack when generating complex types within the document, said complex types selected from the group consisting of: an array, recursion and a complex type being contained within another complex type.

26. The method of claim 25, wherein the state of the stack is maintained by call backs from the compiled template to the mapping interface to indicate when the complex types start and end.

27. The method of claim 21, further comprising calling a getElementRepetitions method to determine how many times the template loops over selected portions of the document.

28. The method of claim 21, wherein the structured language elements represent Extensible Markup Language (XML) constructs and the template is created using JavaServer Pages (JSP).

29. A method of converting a document containing structured language elements to a software object, the method comprising:
(a) supplying the document to an instance of an invoked mapping interface;
(b) registering the mapping interface as a content handler;
(c) parsing the document using an instance of an invoked parser; and
(d) populating the software object with properties associated with structured language elements parsed from the document through call backs made to the mapping interface.

30. The method of claim 29, wherein step (d) includes call backs to invoke methods selected from the group consisting of: startDocument, startElement, characters, endElement, and endDocument.

31. The method of claim 30, wherein the startDocument and startElement methods executed by the mapping interface creates the software object.

32. The method of claim 29, wherein the endElement method executed by the mapping interface sets the properties into the software object.

33. The method of claim 29, wherein the structured language elements represent Extensible Markup Language (XML) constructs.

34. A computer program product for converting a data structure representing a software object to structured language elements of a document, the computer program product comprising computer readable program code devices for:
(a) generating a structured language element template document;
(b) reading properties from the software object, the properties being associated with the structured language elements of the document;
(c) using the properties, obtaining constructs defined by the structured language elements based on the association between the properties and the structured language elements; and
(d) populating the structured language element template document with the constructs.

35. The computer program product of claim 34, wherein step (c) includes direct call back to the software object to obtain events that represent the constructs that define structure and content of the document.

36. The computer program product of claim 34, wherein step (c) includes creating an object model that represents structure and content of the document.

37. The computer program product of claim 34, wherein the structured language elements represent Extensible Markup Language (XML) constructs.

38. The computer program product of claim 34, wherein step (c) includes constructing a loop in the template document to process repeating structures language elements.

39. A computer program product for converting structured language elements of a document to a data structure representing a software object, the computer program product comprising computer readable program code devices for:
(a) reading each of the structured language elements of the document;
(b) determining a property, selected from a set of available properties defined by the data structure of the software object, associated with structured language elements of the document; and
(c) populating the properties of the data structure representing the software object with structured language element values from the document.

40. The computer program product of claim 39, wherein step (a) includes generating events that represent structure and content of the document.

41. The computer program product of claim 39, wherein step (a) includes calling back to a handler with events that represent structure and content of the document.

42. The computer program product of claim 39, wherein step (a) includes creating an object model that represents structure and content of the document.

43. The computer program product of claim 39, wherein the structured language elements represent Extensible Markup Language (XML) constructs and step (a) further includes enforcing Document Type Definition (DTD) and XML schema standards.

44. The computer program product of claim 43, further comprising maintaining a stack for recursive XML constructs.
